(19) United States
(12) Patent Application Publication
(10) Pub. No.: US 2015/0002550 A1
(43) Pub. Date: Jan. 1, 2015

(54) SCREEN SHARING SYSTEM AND METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: XUE-SHUN LIU, Shenzhen (CN); XIN LU, Shenzhen (CN); HUAN-HUAN ZHANG, Shenzhen (CN); JUN-JIE LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/252,025

(22) Filed: Apr. 14, 2014

(30) Foreign Application Priority Data
Jun. 26, 2013 (CN) 201310259111X

(51) Int. Cl. G09G 5/00; G09G 5/373; G09G 5/12

(52) U.S. Cl. CPC G09G 5/005; G09G 5/12; G09G 5/373
USPC 345/660

(57) ABSTRACT

A screen sharing system applied between a mobile terminal and a display terminal is provided. The system includes a sharing instruction generating module, a control module, and an adjusting module. The sharing instruction generating module generates a sharing instruction when a mobile device is sensed by the display terminal within a predetermined distance. The control module controls the mobile terminal to share a current screen with the display terminal by a screen image technology based on the sharing instruction. The adjusting module adjusts a display scale of the shared screen on the display terminal based on a distance between the mobile terminal and the display terminal and a first predetermined function associated with the mobile terminal.

### FIELD

The present disclosure relates to systems, and particularly to a screen sharing system and method.

### BACKGROUND

Because mobile devices usually have a screen having a small size, the screen on the mobile device may be shared with a display terminal having a large size by a screen image technology.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is schematic diagram of an embodiment of a running environment of a screen sharing system.

FIG. 2 is a block diagram of an embodiment of the screen sharing system of FIG. 1.

FIG. 3 is a flowchart diagram of an embodiment of a method for sharing a screen implemented by the screen sharing system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

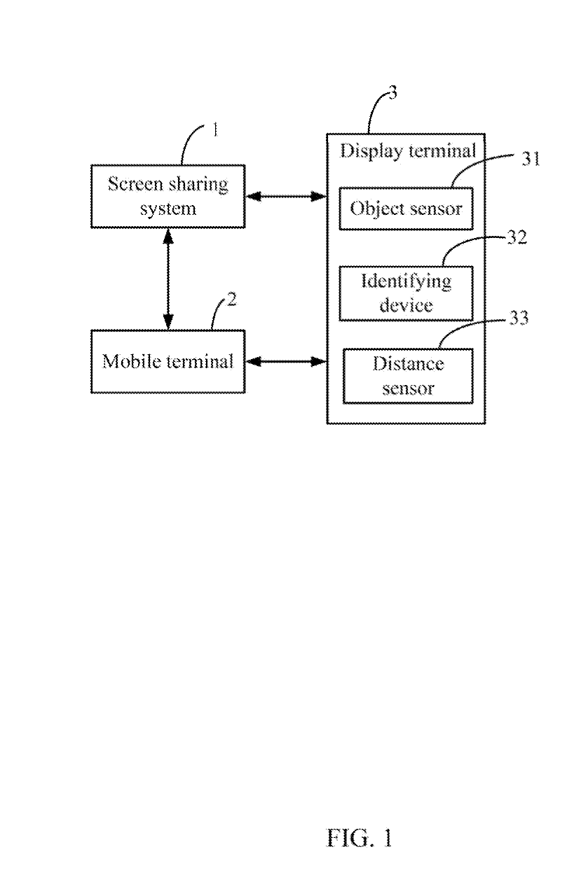

FIG. 1 is a schematic diagram of an embodiment of a running environment of a screen sharing system 1. The running environment of the screen sharing system 1 can include a mobile terminal 2 and a display terminal 3. The mobile terminal 2 is assigned an identifier for identification. The display terminal 3 includes an object sensor 31, an identifying device 32, and a distance sensor 33. The object sensor 31 senses whether there is a mobile terminal 2 within a predetermined distance. The identifying device 32 identifies the identifier of the mobile terminal 2 when the mobile terminal 2 is sensed within the predetermined distance. The distance sensor 33 senses a distance between the mobile terminal 2 and the display terminal 3 in real time. In one embodiment, the mobile terminal 2 is a mobile phone, and the display terminal 3 is a television.

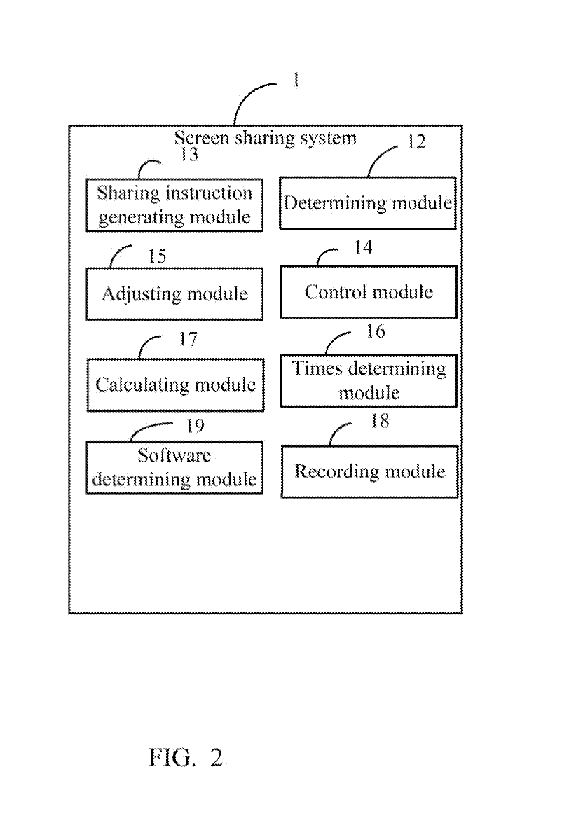

Referring to FIG. 2, the screen sharing system 1 includes a determining module 12, a sharing instruction generating module 13, a control module 14, an adjusting module 15, a times determining module 16, a calculating module 17, a recording module 18, and a software determining module 19. The modules of the screen sharing system 1 are a collection of software instructions executed by one or more processors.

The determining module 12 determines whether the identifier identified by the identifying device 32 is one of a group of predetermined identifiers when the object sensor 31 senses the mobile terminal 2 within the predetermined distance. The mobile terminal 2 with the predetermined identifier has authority to share a current screen with the display terminal 3. The sharing instruction generating module 13 generates a sharing instruction when the identifier is the predetermined identifier. The control module 14 controls the mobile terminal 2 with the predetermined identifier to share a current screen with the display terminal 3 by a screen image technology based on the sharing instruction. The adjusting module 15 adjusts a display scale of the shared screen on the display terminal 3 based on the distance between the mobile terminal 2 and the display terminal 3, and further based on a first predetermined function associated with the mobile terminal 2. In one embodiment, the determining module 12, the sharing instruction generating module 13, and the adjusting module 15, the times determining module 16, the calculating module 17, the recording module 18, and the software determining module 19 run in the display terminal 3, and the control module 14 runs in the mobile terminal 2.

The times determining module 16 determines whether the current screen on the mobile terminal 2 has been shared with the display terminal 3 before. In one embodiment, the times determining module 16 determines whether the identifier of the mobile terminal 2 has been identified before to determine whether the current content on the mobile terminal 2 has been shared with the display terminal before. The adjusting module 15 adjusts the display scale of the shared screen on the display terminal 3 to an optimal display scale based on the distance between the mobile terminal 2 and the display terminal 3 and the first predetermined function associated with the mobile terminal 2. In one embodiment, the first predetermined function can be a nonlinear function or a linear function. In one embodiment, the first predetermined function associated with different mobile terminals 2 can be the same or different from each other.

The calculating module 17 calculates a ratio between the optimal display scale of the shared screen on the display terminal 3 and the distance between the mobile terminal 2 and the display terminal 3 when the display scale of the shared screen is the optimal display scale. The recording module 18 records the ratio. Thus, when the mobile terminal 2 shares a current screen with the display terminal 3 a subsequent time, the adjusting module 15 can automatically adjust the display scale of the shared screen on the display terminal 3 based on the recorded ratio and the distance between the mobile terminal 2 and the display terminal 3.

In one embodiment, when the mobile terminal 2 shares the current screen with the display terminal 3 for the first time, the first predetermined function is defined as Y=X*X+3, wherein Y represents the display scale of the shared screen on the display terminal 3, and X represents the distance between the mobile terminal 2 and the display terminal 3. For example, when X equals 2, Y equals 7. Thus, the ratio equals 7/2. When the mobile terminal 2 shares the current screen with the display terminal 3 for the subsequent time, if X equals 3, the display scale of the shared screen is obtained by multiplying 7/2 by 3, and is equal to 21/2. Thus, the adjusting module 15 adjusts the display scale of the shared screen to 21/2.

The software determining module 19 determines an application whose current screen is shared with the display terminal 3. Each application installed on the mobile terminal 2 is associated with a second predetermined function and is assigned with a unique identifier for identification. The software determining module 19 acquires the unique identifier and determines the application based on the acquired unique identifier. The times determining module 16 determines whether the screen of the application has been shared with the display terminal 3 before. In one embodiment, the times determining module 16 determines whether the unique identifier of the application has been identified before to determine whether the screen of the application has been shared with the display terminal 3 before. The adjusting module 15 adjusts the display scale of the shared screen on the display terminal 3 to the optimal display scale based on the distance between the mobile terminal 2 and the display terminal 3 and the second predetermined function associated with the application. In one embodiment, the second predetermined function can be a nonlinear function or a linear function. The calculating module 17 calculates a ratio between the optimal display scale of the shared screen on the display terminal 3 and the distance between the mobile terminal 2 and the display terminal 3 when the display scale is the optimal display scale. The recording module 18 records the ratio. The adjusting module 15 adjusts the display scale of the shared screen on the display terminal 3 based on the recorded ratio and the distance between the mobile terminal 2 and the display terminal 3 when the current screen of the application on the mobile terminal 2 is shared with the display terminal 3 a subsequent time. In one embodiment, the second predetermined function associated with different application can be the same or different from each other.

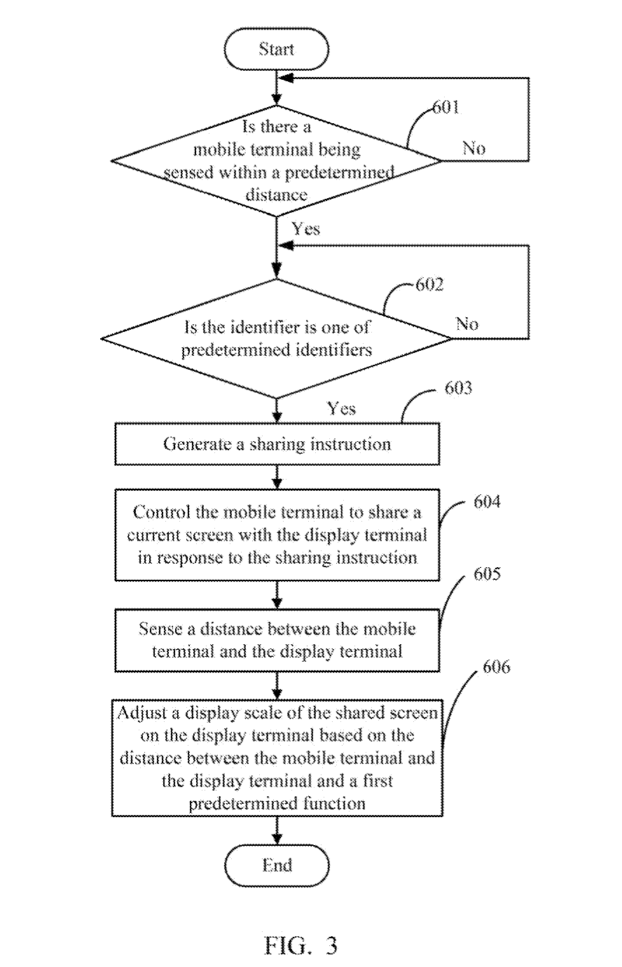

FIG. 3 is a flowchart diagram of an embodiment of a method for sharing a screen.

In 601, the object sensor 31 senses whether there is a mobile terminal 2 being sensed within a predetermined distance. If yes, the procedure goes to 602. If no, the procedure goes to step 601.

In step 602, the determining module 12 determines whether the identifier identified by the identifying device 32 is one of the predetermined identifiers. If yes, the procedure goes to step 603. If no, the procedure goes to step 602.

In 603, the sharing instruction generating module 13 generates a sharing instruction.

In 604, the control module 14 controls the mobile terminal 2 to share a current screen with the display terminal 3 by a screen image technology based on the sharing instruction.

In 605, the distance sensor 33 senses the distance between the mobile terminal 2 and the display terminal 3.

In 606, the adjusting module 15 adjusts a display scale of the shared screen on the display terminal 3 based on the distance between the mobile terminal 2 and the display terminal 3 and the first predetermined function.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A screen sharing system applied in a running environment comprising a mobile terminal and a display terminal, comprising:
one or more processor; and
a plurality of modules to be executed by the one or more processor, wherein the plurality of modules comprise:
a sharing instruction generating module configured to generate a sharing instruction when a mobile terminal is sensed by the display terminal within a predetermined distance;
a control module configured to control the mobile terminal to share a current screen with the display terminal by a screen image technology based on the sharing instruction; and
an adjusting module configured to adjust a display scale of the shared screen on the display terminal based on a distance between the mobile terminal and the display terminal and a first predetermined function associated with the mobile terminal.

2. The screen sharing system as described in claim 1, wherein the plurality of modules further comprise:
a determining module configured to determine whether an identifier of the mobile terminal, which is identified by an identifying device, is one of a group of predetermined identifiers, when the mobile terminal is sensed by the display terminal within the predetermined distance; and
the sharing instruction generating module configured to generate the sharing instruction when the identifier of the mobile terminal is one of the predetermined identifiers.

3. The screen sharing system as described in claim 1, wherein the plurality of modules further comprise:
a times determining module configured to determine whether the current screen on the mobile terminal has been shared with the display terminal before;
the adjusting module configured to adjust the display scale of the shared screen on the display terminal based on the distance between the mobile terminal and the display terminal and the first predetermined function associated with the mobile terminal to an optimal display scale when the current screen on the mobile terminal has been shared with the display terminal before;
a calculating module configured to calculate a ratio between the optimal display scale and the distance between the mobile terminal and the display terminal; and
a recording module configured to record the ratio.

4. The screen sharing system as described in claim 3, wherein the adjusting module adjusts the display scale of the shared screen on the display terminal based on the recorded ratio and the distance between the mobile terminal and the display terminal when the current screen on the mobile terminal is shared with the display terminal a subsequent time.

5. The screen sharing system as described in claim 1, wherein the plurality of modules further comprise:
a software determining module configured to determine an application whose current screen is shared with the display terminal;
a times determining module configured to determine whether the current screen of the application has been shared with the display terminal before;
the adjusting module configured to adjust the display scale of the shared screen on the display terminal, based on the distance between the mobile terminal and the display terminal and a second predetermined function associated with the application installed on the mobile terminal to an optimal display scale, when the current screen of the application has been shared with the display terminal before;
a calculating module configured to calculate a ratio between the optimal display scale and the distance between the mobile terminal and the display terminal when the display scale is the optimal display scale; and
a recording module configured to record the ratio.

6. The screen sharing system as described in claim 5, wherein the adjusting module is further configured to adjust the display scale of the shared screen on the display terminal based on the recorded ratio and the distance between the mobile terminal and the display terminal when the current screen of the application on the mobile terminal has been shared with the display terminal a subsequent time.

7. A screen sharing method applied in a running environment comprising a mobile terminal and a display terminal, the method comprising:
generating a sharing instruction when the mobile terminal is sensed by the display terminal within a predetermined distance;
controlling the mobile terminal to share a current screen with the display terminal by a screen image technology the sharing instruction; and
adjusting a display scale of the shared screen on the display terminal based on a distance between the mobile terminal and the display terminal and a first predetermined function associated with the mobile terminal.

8. The screen sharing method as described in claim 7, further comprising:
determining whether the identifier of the mobile terminal which is identified by an identifying device, is one of a group of predetermined identifiers when the mobile terminal is sensed by the display terminal within the predetermined distance; and
generating the sharing instruction when the identifier of the mobile terminal is one of the predetermined identifiers.

9. The screen sharing method as described in claim 7, further comprising:
determining whether the current screen on the mobile terminal has been shared with the display terminal before;
adjusting the display scale of the shared screen on the display terminal based on the distance between the mobile terminal and the display terminal and the first predetermined function associated with the mobile terminal to an optimal display scale when the current screen on the mobile terminal has been shared with the display terminal before;
calculating a ratio between the optimal display scale and the distance between the mobile terminal and the display terminal; and
recording the ratio.

10. The screen sharing method as described in claim 9, further comprising:
adjusting the display scale of the shared screen on the display terminal based on the recorded ratio and the distance between the mobile terminal and the display terminal when the current screen on the mobile terminal is shared with the display terminal a subsequent time.

11. The screen sharing method as described in claim 7, further comprising:
determining an application whose current screen is shared with the display terminal;
determining whether the current screen of the application with the type on the mobile terminal has been shared with the display terminal before;
adjusting the display scale of the shared screen on the display terminal based on the distance between the mobile terminal and the display terminal and a second predetermined function associated with the application installed on the mobile terminal to an optimal display scale when the current screen of the application on the mobile terminal has been shared with the display terminal before;
calculating a ratio between the display scale and the distance between the mobile terminal and the display terminal when the display scale is the optimal display scale; and
recording the ratio.

12. The screen sharing method as described in claim 11, further comprising:
adjusting the display scale of the shared screen on the display terminal based on the recorded ratio and the distance between the mobile terminal and the display terminal when the current screen of the application on the mobile terminal has been shared with the display terminal a subsequent time.
